(19) United States
(12) Patent Application Publication
(10) Pub. No.: US 2006/0033329 A1
(43) Pub. Date: Feb. 16, 2006

(54) Connecting structure for connecting a circuit section to a chamber, and fuel cell comprising same

(76) Inventors: Thierry Novet, Bernin (FR); Patrick Sanglan, Seyssins (FR); Frederic Barth, Annecy-Le-Vieux (FR); Pierre Charlat, Lans En Vercors (FR)

Correspondence Address: AIR LIQUIDE, 2700 POST OAK BOULEVARD, SUITE 1800, HOUSTON, TX, 77056, US

(21) Appl. No.: 10/532,778

(22) PCT Filed: Oct. 13, 2003
(86) PCT No.: PCT/FR03/50086

§ 371 Date: Apr. 22, 2005

(30) Foreign Application Priority Data
Oct. 29, 2002 (FR) 02/13527

(51) Int. Cl. F16L 41/08

(52) U.S. Cl. 285/189; 285/222; 285/382.5

(57) ABSTRACT

Connecting structures made of a tubular metal element. The structure has a tubular metal element which is connected to the orifice of a chamber. The chamber is made of a thin metal sheet. The structure also has a duct shaped connecting member which is sealed onto the other end of the tubular metal element. The structure may be used for producing fuel cells when the plate which forms parallel channels, is a current collector with gas circulating channels in contact with a proton-exchanging membrane.

Connecting structure for connecting a fluid circuit section to a chamber, and fuel cell comprising same.

The present invention relates to connecting structures between a fluid circuit section and a chamber delimited on at least one side by a thin metal sheet provided with at least one orifice for access to the chamber.

The connection of a tube to a thin metal sheet presents many difficulties, both in the mechanical strength and the seal, in particular with metal sheets that are difficult to weld such as alloyed steels. The difficulties are even greater when the chamber has a greatly reduced effective internal volume. The problems are further increased according to the fluids concerned, aggressive or oxidizing, as is the case in particular in fuel cells.

The object of the present invention is to propose a simple, compact and reliable connecting structure, including with very thin metal sheets, less than 0.4 mm, and with greatly reduced chamber volumes.

To do this, according to the invention, the connecting structure comprises a tubular metal element having a first end set into the orifice of the metal sheet and a second end that can be connected to the circuit section typically via a connecting member, advantageously made of plastic, comprising a duct receiving at least the second end of the tubular element and secured in sealed manner to the latter.

According to the more particular features of the invention:
the element and the metal sheet are made of one and the same grade of metal, typically of stainless steel,
the connecting member comprises an internal chamber that can be connected to the circuit section.

The present invention also relates to a fuel cell in which the metal sheet forms, by stamping, a series of parallel ducts and is coupled in sealed manner to a proton-exchange membrane.

Other features and advantages of the invention will emerge from the following description of embodiments, given for illustrative purposes but in no way limiting, made in relation to the appended drawings, in which:

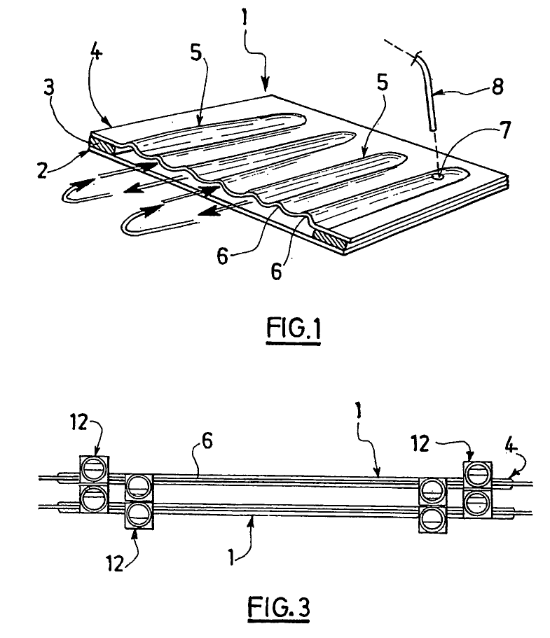

FIG. 1 is a schematic view in perspective of a half fuel cell showing the configuration of the stamp-formed metal sheet;

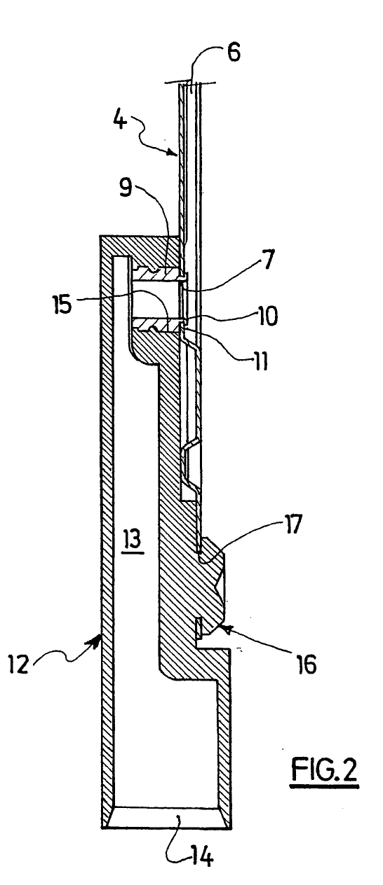

FIG. 2 is an enlarged schematic view in section of a connecting structure according to the invention, and

FIG. 3 is a top view of two adjacent cells of a fuel cell provided with connecting structures according to the invention.

FIG. 1 shows a half-cell 1 of a fuel cell in cross-section with its proton-exchange membrane 2 against which is pressed, with interposition of a peripheral seal 3, a stamped metal sheet 4 to form undulations 5 whose internal peaks bear in sealed manner against the membrane 2 thereby to define parallel ducts 6 allowing the gases to circulate along the membrane, as indicated by the arrows, the electricity produced being carried by the metal of the metal sheet, typically made of stainless steel.

To make compact structures, such as that shown in FIG. 3, the metal sheet 4, typically made of stainless steel, has a thickness of less than 0.5 mm, typically less than 0.4 mm. The ducts 6 have a height (wave amplitude) of less than 5 mm, typically less than 2 mm. The lateral ducts of the metal sheet 4 are each provided, at one of their ends, with an access orifice 7 for the connection to a fluid circuit section 8, the fluid typically being hydrogen on the one hand and a gas mix containing oxygen on the other hand in the case of fuel cells.

In the embodiment shown in FIG. 2, the connecting structure according to the invention for connecting the fluid circuit section 8 to the orifice 7 of the metal sheet 4 comprises a tubular metal element 9, typically also made of stainless steel, with an overall diameter slightly greater than that of the orifice 7 and comprising a thinned end 10 of small axial extension (of the order of twice the thickness of the metal sheet 4) and substantially with the same diameter as that of the orifice 7 in order to be inserted into the latter with the rear shoulder 11 pressing against the outer surface of the metal sheet 4. Then, the protruding end of the thinned end 10, with a thickness lying between 0.05 and 0.5 mm, preferably between 0.1 and 0.3 mm, is set in sealed manner into the hole 7, thus fixedly attaching in sealed manner the tubular element 9 to the metal sheet 4.

The connecting structure also comprises a connecting member 12, advantageously made of molded polymer, of a generally elongated configuration, defining an inner tubular chamber 13 having a main direction culminating at one end in an enlarged diameter connection orifice 14 and, at the other end, in a duct 15 extending orthogonally to the chamber. The internal diameter of the duct 15 is slightly greater than the external diameter of the tubular element 9 and the latter is force-fitted into the duct 15 with the application of ultrasounds which cause a total or partial fusion of the edges of the duct while thus fixedly attaching in sealed manner the tubular element 9 to the connecting member 12 whose outer face, in which the duct 15 culminates, comes to bear on the outer face of the metal sheet 4. In assembled configuration, the chamber 13 extends parallel to the metal sheet 4, beyond the latter, thus making it easy to connect the connecting orifice to the fluid section 8.

In the embodiment shown, the connecting member 12 also comprises a pin 16 parallel to the duct 15 which is positioned in a hole 17 formed in the flat peripheral zone of the metal sheet 4, the pin being deformed when hot or by heading to consolidate the positioning and retention of the member 12 relative to the metal sheet 4.

The connecting orifice 14 may be of a shape and dimension suitable for allowing any type of sealed connection, advantageously removable, at a tube end such as the circuit section 8.

Although the invention has been described in relation to embodiments, it is not limited thereby, but is susceptible to modifications and variants which will be evident to those skilled in the art in the context of the claims hereinafter.

1-10. (canceled)

11-20. (canceled)

21. An apparatus which may be used as a connecting structure for connecting a fluid circuit section to a chamber, said apparatus comprising:
a) a tubular metal element, wherein:
1) said tubular metal element comprises:
i) a first tubular element end; and
ii) a second tubular element end;
2) said first tubular element end is connected to the orifice of a chamber; and
3) said chamber comprises:
i) at least one side made of a thin metal sheet; and
ii) said orifice; and
b) a connecting member, wherein:
1) said connecting member comprises a duct; and
2) said second tubular element end interfaces with, and is sealed to, said duct.

22. The apparatus of claim 21, wherein the thickness of said metal sheet is less than or equal to about 0.4 mm.

23. The apparatus of claim 21, wherein both said metal sheet and said tubular element are made of substantially the same grade of metal.

24. The apparatus of claim 23, wherein both said metal sheet and said tubular element are made of stainless steel.

25. The apparatus of claim 21, wherein said connecting member further comprises an internal chamber suitable for connection to a fluid circuit section.

26. The apparatus of claim 25, wherein said connecting member is made of plastic.

27. The apparatus of claim 25, wherein:
a) said connecting member further comprises a protruding portion; and
b) said protruding portion is secured to said metal sheet.

28. The apparatus of claim 25, wherein said internal chamber has a main direction which is substantially parallel to said metal sheet.

29. The apparatus of claim 21, wherein:
a) said metal sheet is stamped to form a series of parallel ducts;
b) said metal sheet is sealed to a membrane in order to form a fuel cell; and
c) said orifice is located near the end of at least one said parallel duct.

30. An apparatus which may be used as a fuel cell, said apparatus comprising a connecting structure for connecting a fluid circuit section to a chamber, said structure comprising:
a) a tubular metal element, wherein:
1) said tubular metal element comprises:
i) a first tubular element end; and
ii) a second tubular element end;
2) said first tubular element end is connected to the orifice of a chamber; and
3) said chamber comprises:
i) at least one side made of a thin metal sheet; and
ii) said orifice; and
b) a connecting member, wherein:
1) said connecting member comprises a duct; and
2) said second tubular element end interfaces with, and is sealed to, said duct.

31. The apparatus of claim 30, wherein the thickness of said metal sheet is less than or equal to about 0.4 mm.

32. The apparatus of claim 30, wherein both said metal sheet and said tubular element are made of substantially the same grade of metal.

33. The apparatus of claim 30, wherein said connecting member further comprises an internal chamber suitable for connection to a fluid circuit section.

34. The apparatus of claim 33, wherein:
a) said connecting member further comprises a protruding portion; and
b) said protruding portion is secured to said metal sheet.

35. The apparatus of claim 30, wherein:
a) said metal sheet is stamped to form a series of parallel ducts;
b) said metal sheet is sealed to a membrane in order to form a fuel cell; and
c) said orifice is located near the end of at least one said parallel duct.
